(19) United States
(12) Patent Application Publication
(10) Pub. No.: US 2011/0202592 A1
(43) Pub. Date: Aug. 18, 2011

(54) Use of Multiple Connections to Extend RADIUS Identifier Space

(76) Inventors: Justin Hart, Old Town (GB); Himanshoo Kumar Saxena, Navi Mumbai (IN)

(21) Appl. No.: 12/706,561

(22) Filed: Feb. 16, 2010

(51) Int. Cl. G06F 21/00; G06F 15/16

(52) U.S. Cl. 709/203; 726/3

(57) ABSTRACT

A system and method is provided for accounting and authentication that communicates via RADIUS protocol. Multiple RADIUS clients are associated with multiple sets of RADIUS protocol identifiers, such that the number of available RADIUS protocol identifiers available for services request is increased.

### FIELD OF THE INVENTION

The present invention pertains to communication between RADIUS clients and RADIUS servers, and in particular, to extending the number of available RADIUS identifiers to assign to RADIUS messages.

### BACKGROUND OF THE INVENTION

Remote Authentication Dial In User Service (RADIUS) is a client/server protocol that runs in an Internet Protocol (IP) application layer, using User Datagram Protocol (UDP) ports as a transport. The RADIUS protocol is commonly used in IP applications for authentication, authorization, and accounting for computers to connect to and use a network service. The RADIUS protocol is defined by an IP standard known as RFC 2138.

RADIUS is typically used by a client to request authentication from a server and to subsequently notify the server of significant accounting events, for example, START billing, and STOP billing. Typically, the client requests a particular service or notifies the server of a particular event. The server acknowledges the client requests and responds either positively or negatively.

The RADIUS protocol includes an 8-bit identifier field (ID) within each RADIUS message to uniquely identify each client's transaction requests and match each server's response. The server uses the ID field (in conjunction with IP addressing) to verify and/or terminate duplicate requests it receives. The client also uses the ID field to pair up server responses with outstanding requests. The RADIUS protocol only allows for 256 active client requests pending at one time because the ID field is only 8-bits. The time it takes a client/server transaction to complete affects the total number of transactions that the server can complete in a particular duration. For example, a client that is capable of 300 connections per second requires a time of approximately 0.8 seconds or better for a client/server transaction to complete, to avoid running out of unassigned identifiers.

A client/server transaction is complete once a) a client request is transmitted to the server, b) the sever processes the request and c) the server transmits a response back to the client. The amount of time it takes a client/server transaction to complete depends on, for example, latency of the client/server network, the server's processing time, the client's processing time on each end of the transaction, and the number of times a client retransmits a request in the event that a first transmission failed.

### SUMMARY OF THE INVENTION

A system and method is provided for extending a number of RADIUS protocol identifiers available for use with RADIUS protocol sessions by implementing multiple logical and/or physical RADIUS clients, UDP ports, RADIUS servers and/or RADIUS server groups.

The invention, in one aspect, features a computer-implemented method for an authentication and accounting system which communicates via a RADIUS protocol. The computer-implemented method involves, determining, by a client computer, a status flag for each RADIUS protocol identifier in a first set of RADIUS protocol identifiers associated with a first RADIUS client and a second set of RADIUS protocol identifiers associated with a second RADIUS client, wherein the determination is based on whether each RADIUS protocol identifier is in use by an existing RADIUS transaction. The computer-implemented method also involves, initiating, by the client computer, a RADIUS transaction with one identifier, selected from the combination of the first set of RADIUS protocol identifiers and the second set of RADIUS protocol identifiers, based on the status flag of each of the RADIUS identifiers in the first set of RADIUS protocol identifiers and the second set of RADIUS protocol identifiers.

In some embodiments, each RADIUS protocol identifier in the first set of RADIUS protocol identifiers and the second set of RADIUS protocol identifiers is assigned when the status flag is present and unassigned when the status flag is not present.

In some embodiments, initiating a RADIUS transaction with the one identifier includes determining, by the client computer, utilization parameters for each of the first set of RADIUS protocol identifiers and the second set of RADIUS protocol identifiers and selecting the one identifier from the combination of the first set of RADIUS protocol identifiers and the second set of RADIUS protocol identifiers, based on the utilization parameters.

In some embodiments, determining utilization parameters includes determining a first number of RADIUS protocol identifiers in the first set of RADIUS protocol identifiers that are used by RADIUS transactions and determining a second number of RADIUS protocol identifiers in the second set of RADIUS protocol identifiers that are used by the RADIUS transactions.

In some embodiments, determining the utilization parameters includes determining a first response time of a first RADIUS server associated with the first set of RADIUS protocol identifiers and determining a second response time of a second RADIUS server associated with the second set of RADIUS protocol identifiers.

In some embodiments, the computer-implemented method involves tracking use of the first set of RADIUS protocol identifiers and the second set of RADIUS protocol identifiers by RADIUS transactions. In some embodiments, the computer-implemented method involves tracking by associating a first transaction array with the first set of RADIUS protocol identifiers and a second transaction array with the second set of RADIUS protocol identifiers, wherein each transaction array includes 256 slots that correspond to 256 identifiers available for RADIUS protocol identifiers and inserting an assigned status into a slot of the first transaction array or the second transaction array based on the RADIUS protocol identifier and the set of RADIUS protocol identifiers used to initiate each RADIUS transaction.

In some embodiments, the computer-implemented method involves deleting the assigned status from the slot of the first transaction array or second transaction array based on receiving, by the client computer, an indication from a RADIUS server that the RADIUS transaction has ended. In some embodiments, selecting the one identifier is further based on a first number of active transactions between the first RADIUS server associated with the first RADIUS client and a second number of active transactions between the first RADIUS server associated with a third client computer.

In some embodiments, selecting the one identifier is further based on whether the first RADIUS client associated with a RADIUS server or the second RADIUS client associated with the RADIUS server has more active transactions. In some embodiments, selecting the one identifier is further based on whether the first RADIUS client or the second RADIUS client was last used to initiate a RADIUS transaction.

In some embodiments, the first RADIUS client is implemented on a second computer and the second RADIUS client is implemented on a third computer. In some embodiments, the client computer includes a third set of RADIUS protocol identifiers associated with a third RADIUS client, and wherein the one identifier is selected from a combination of the first set of RADIUS protocol identifiers, the second set of RADIUS protocol identifiers and third set of RADIUS protocol identifiers.

The invention, in one aspect, features a computer-implemented method for an authentication and accounting system which communicates via a RADIUS protocol. The computer-implemented method involves, determining, by a client computer, a status flag for each RADIUS protocol identifier in a first set of RADIUS protocol identifiers associated with a first UDP port and a second set of RADIUS protocol identifiers associated with a second UDP port, wherein the determination is based on whether each RADIUS protocol identifier is in use by an existing RADIUS transaction. The computer-implemented method also involves initiating, by the client computer, a RADIUS transaction with one identifier selected from the combination of the first set of RADIUS protocol identifiers and the second set of RADIUS protocol identifiers based on the status of each of the RADIUS protocol identifiers in the first set of RADIUS protocol identifiers and the second set of RADIUS protocol identifiers.

In some embodiments, each RADIUS protocol identifier in the first set of RADIUS protocol identifiers and the second set of RADIUS protocol identifiers is assigned when the status flag is present and unassigned when the status flag is not present.

In some embodiments, initiating a RADIUS transaction with the one identifier includes determining, by the client computer, utilization parameters for each of the first set of RADIUS protocol identifiers and the second set of RADIUS protocol identifiers and selecting the one identifier from the combination of the first set of RADIUS protocol identifiers and the second set of RADIUS protocol identifiers, based on the utilization parameters.

In some embodiments, determining the utilization parameters includes determining a first number of RADIUS protocol identifiers in the first set of RADIUS protocol identifiers that are used by RADIUS transactions and determining a second number of RADIUS protocol identifiers in the second set of RADIUS protocol identifiers that are used by the RADIUS transactions.

In some embodiments, determining the utilization parameters includes determining a first response time of a first RADIUS server associated with the first set of RADIUS protocol identifiers and determining a second response time of a second RADIUS server associated with the second set of RADIUS protocol identifiers.

In some embodiments, the computer-implemented method involves tracking use of the first set of RADIUS protocol identifiers and the second set of RADIUS protocol identifiers by RADIUS transactions.

In some embodiments, the computer-implemented method involves tracking by associating a first transaction array with the first set of RADIUS protocol identifiers and a second transaction array with the second set of RADIUS protocol identifiers, wherein each transaction array includes 256 slots that correspond to 256 identifiers available for RADIUS protocol identifiers and inserting an assigned status into a slot of the first transaction array or the second transaction array based on the RADIUS protocol identifier and the set of RADIUS protocol identifiers used to initiate each RADIUS transaction.

In some embodiments, deleting the assigned status from the slot of the first transaction array or second transaction array is based on receiving, by the client computer, an indication from a RADIUS server that the RADIUS transaction has ended. In some embodiments, selecting the one identifier is further based on whether the first UDP port or the second UDP port was last used to initiate a RADIUS transaction.

The invention, in one aspect, features a computer-implemented method an authentication and accounting system which communicates via a RADIUS protocol. The computer-implemented method involves determining, by a client computer, a status flag for each RADIUS protocol identifier in i) a first set of RADIUS protocol identifiers associated with a first UDP port and a first RADIUS client, ii) a second set of RADIUS protocol identifiers associated with the first UDP port and a second RADIUS client, iii) a third set of RADIUS protocol identifiers associated with a second UDP port and the first RADIUS client, and iv) a fourth set of RADIUS protocol identifiers associated with the second UDP port and the second RADIUS client, wherein the determination is based on whether each RADIUS protocol identifier is in use by an existing RADIUS transaction. The computer-implemented method also involves initiating, by the client computer, a RADIUS transaction with one identifier selected from the combination of the first set of RADIUS protocol identifiers, the second set of RADIUS protocol identifiers, the third set of RADIUS protocol identifiers and the fourth set of RADIUS protocol identifiers based on the status and of each of the RADIUS protocol identifiers in the first set of RADIUS protocol identifiers, the second set of RADIUS protocol identifiers, the third set of RADIUS protocol identifiers and the fourth set of RADIUS protocol identifiers.

In some embodiments, initiating a RADIUS transaction with the one identifier includes determining, by the client computer, utilization parameters for each of the first set of RADIUS protocol identifiers, the second set of RADIUS protocol identifiers, the third set of RADIUS protocol identifiers and the fourth set of RADIUS protocol identifiers and selecting the one identifier from the combination of the first set of RADIUS protocol identifiers, the second set of RADIUS protocol identifiers, the third set of RADIUS protocol identifiers and the fourth set of RADIUS protocol identifiers, based on the utilization parameters.

The invention, in one aspect, features a computer-implemented method for an authentication and accounting system which communicates via a RADIUS protocol. The computer-implemented method involves determining, by a client computer, a status flag for each RADIUS protocol identifier in one or more sets of RADIUS protocol identifiers associated with a RADIUS client and an UDP port, wherein the determination is based on whether each RADIUS protocol identifier is in use by an existing RADIUS transaction. The computer-implemented method also involves initiating, by the client computer, a RADIUS transaction with one identifier selected from the one or more RADIUS protocol identifiers based on the status and of each of the RADIUS protocol identifiers in the one or more sets of RADIUS protocol identifiers.

In some embodiments, initiating a RADIUS transaction with the one identifier includes determining, by the client computer, utilization parameters for each of the one or more sets of RADIUS protocol identifiers and selecting the one identifier from the combination of the one or more sets of RADIUS protocol identifiers, based on the utilization parameters.

The invention, in one aspect, features a computer-implemented method for an authentication and accounting system which communicates via a RADIUS protocol. The computer-implemented method involves determining, by a client computer, a status flag for each RADIUS protocol identifier in i) a first set of RADIUS protocol identifiers associated with a first RADIUS client and a UDP port, ii) a second set of RADIUS protocol identifiers associated with a second RADIUS client and the UDP port, wherein the determination is based on whether each RADIUS protocol identifier is in use by an existing RADIUS transaction. The computer-implemented method also involves initiating, by the client computer, a RADIUS transaction with one identifier selected from the combination of the first set of RADIUS protocol identifiers and the second set of RADIUS protocol identifiers based on the status and of each of the RADIUS protocol identifiers in the first set of RADIUS protocol identifiers and the second set of RADIUS protocol identifiers.

In some embodiments, initiating a RADIUS transaction with the one identifier includes determining, by the client computer, utilization parameters for each of the first set of RADIUS protocol identifiers and the second set of RADIUS protocol identifiers and selecting the one identifier from the combination of the first set of RADIUS protocol identifiers and the second set of RADIUS protocol identifiers, based on the utilization parameters.

The invention, in one aspect, features a computer-implemented method for an authentication and accounting system which communicates via a RADIUS protocol. The computer-implemented method involves determining, by a client computer, unique UDP port and RADIUS client pairs, wherein each unique UDP port and RADIUS client pair includes i) a single UDP port from two or more UDP ports associated with the client computer, and ii) a single RADIUS client from two or more RADIUS clients associated with the client computer. The computer-implemented method also involves determining, by the client computer, a status flag for each RADIUS protocol identifier in two or more sets of RADIUS protocol identifiers, wherein each set of the two or more sets of RADIUS protocol identifiers is associated with a unique UDP port and RADIUS client pair, and wherein the determination is based on whether each RADIUS protocol identifier is in use by an existing RADIUS transaction. The computer-implemented method also involves initiating, by the client computer, a RADIUS transaction with one identifier selected from the combination of the two or more sets of RADIUS protocol identifiers based on the status of each of the RADIUS protocol identifiers in the two or more sets of RADIUS identifiers.

In some embodiments, initiating a RADIUS transaction with the one identifier includes determining, by the client computer, utilization parameters for each of the two or more sets of RADIUS protocol identifiers and selecting the one identifier from the combination of the two or more sets of RADIUS protocol identifiers, based on the utilization parameters.

The invention, in one aspect, features a computer program product for an authentication and accounting system which communicates via a RADIUS protocol, tangibly embodied in a computer-readable storage medium. The computer program product contains instructions operable to cause a data processing apparatus to determine, by a client computer, unique UDP port and RADIUS client pairs, wherein each unique UDP port and RADIUS client pair includes: i) a single UDP port from two or more UDP ports associated with the client computer, and ii) a single RADIUS client from two or more RADIUS clients associated with the client computer. The computer program product also determines, by the client computer, a status flag for each RADIUS protocol identifier in two or more sets of RADIUS protocol identifiers, wherein each set of the two or more sets of RADIUS protocol identifiers is associated with a unique UDP port and RADIUS client pair, and wherein the determination is based on whether each RADIUS protocol identifier is in use by an existing RADIUS transaction. The computer program product also initiates, by the client computer, a RADIUS transaction with one identifier selected from the combination of the two or more sets of RADIUS protocol identifiers based on the status of each of the RADIUS protocol identifiers in the two or more sets of RADIUS identifiers and the load values.

In some embodiments, initiating a RADIUS transaction with the one identifier includes determining, by the client computer, utilization parameters for each of the two or more sets of RADIUS protocol identifiers and selecting the one identifier from the combination of the two or more sets of RADIUS protocol identifiers, based on the utilization parameters.

The invention, in one aspect, features a system for an authentication and accounting system which communicates via a RADIUS protocol. The system includes means for determining, by a client computer, unique UDP port and RADIUS client pairs, wherein each unique UDP port and RADIUS client pair includes i) a single UDP port from two or more UDP ports associated with the client computer, and ii) a single RADIUS client from two or more RADIUS clients associated with the client computer. The system also includes means for determining, by the client computer, a status flag for each RADIUS protocol identifier in two or more sets of RADIUS protocol identifiers, wherein each set of the two or more sets of RADIUS protocol identifiers is associated with a unique UDP port and RADIUS client pairs, and wherein the determination is based on whether each RADIUS protocol identifier is in use by an existing RADIUS transaction. The system also includes means for initiating, by the client computer, a RADIUS transaction with one identifier selected from the combination of the two or more sets of RADIUS protocol identifiers based on the status of each of the RADIUS protocol identifiers in the two or more sets of RADIUS identifiers.

In some embodiments, initiating a RADIUS transaction with the one identifier includes means for determining, by the client computer, utilization parameters for each of the two or more sets of RADIUS protocol identifiers and means for selecting the one identifier from the combination of the two or more sets of RADIUS protocol identifiers, based on the utilization parameters.

The invention, in one aspect, features a computer-implemented method for an authentication and accounting system which communicates via a RADIUS protocol. The computer-implemented method involves determining, by a first client computer, a first set of unique UDP port and RADIUS client pairs, wherein each unique UDP port and RADIUS client pair in the first set includes i) a single UDP port from two or more UDP ports associated with the first client computer, and ii) a single RADIUS client from two or more RADIUS clients associated with the first client computer. The computer-implemented method also involves replicating, by a second client computer, the first set of unique UDP port and RADIUS client pairs determined by the first client computer. The computer-implemented method also involves determining, by the second client computer, a temporary set of unique UDP port and RADIUS client pairs, wherein each unique UDP port and RADIUS client pair in the temporary set includes i) a single UDP port from two or more UDP ports associated with the second client computer, and ii) a single RADIUS client from two or more RADIUS clients associated with the second client computer. The computer-implemented method also involves initiating, by the second client computer, one or more RADIUS transactions with identifiers selected from the temporary set of unique UDP port and RADIUS client pairs in response to the detection of a failure event on the first client computer, wherein the one or more RADIUS transactions remain active for a predetermined duration. The computer-implemented method also involves initiating, by the second client computer, one or more RADIUS transactions with identifiers selected from the first set of unique UDP port and RADIUS client pairs in response to expiration of the predetermined duration.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing a RADIUS client and a RADIUS server, according to the prior art.

FIG. 2A is a block diagram showing RADIUS clients and RADIUS servers, according to an illustrative embodiment of the invention.

FIG. 2B is a block diagram showing details of a RADIUS client, according to an illustrative embodiment of the invention.

FIG. 3 is a block diagram showing a RADIUS client with multiple UDP ports and RADIUS servers, according to an illustrative embodiment of the invention.

FIG. 4 is a block diagram showing RADIUS clients, UDP ports and RADIUS server groups.

FIG. 5 is a flowchart illustrating a method for an authentication and accounting system which communicates via a RADIUS protocol, according to an illustrative embodiment of the invention.

FIG. 6 is a flowchart illustrating a method for an authentication and accounting system which communicates via a RADIUS protocol, according to an illustrative embodiment of the invention.

FIG. 7 is a flowchart illustrating a method for an authentication and accounting system which communicates via a RADIUS protocol, according to an illustrative embodiment of the invention.

### DETAILED DESCRIPTION OF ILLUSTRATIVE EMBODIMENTS

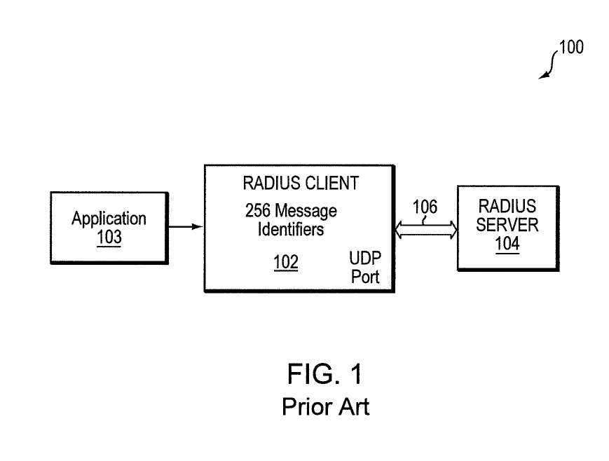

FIG. 1 is a block diagram 100 showing an exemplary RADIUS client 102 and a RADIUS server 104, according to the prior art. The RADIUS client 102 receives requests for services from applications 103 (e.g., IP based phone service). The RADIUS client 102 executes each request by communicating with the RADIUS server 104 via transmission of a RADIUS protocol message 106 over a UDP port.

The RADIUS protocol includes an identifier field used by the RADIUS client 102 and the RADIUS server 104 to uniquely identify each RADIUS protocol message. The RADIUS protocol's identifier field size is 8-bits, allowing for 256 unique combinations of ones and zeros, thus 256 unique identifiers (e.g., 0 to 255).

Upon receipt of a request for services, the RADIUS client 102 creates an instance of a RADIUS protocol message 106 and selects one of the 256 RADIUS protocol identifiers to populate the identifier field of the RADIUS protocol message 106. The RADIUS client 102 selects an identifier that is not currently in use by an existing RADIUS transaction. If all of the identifiers are currently in use, then the request for services is queued by the RADIUS client 102 until an identifier becomes available.

In one embodiment, the RADIUS client 102 declares a request for services as failed if a duration that the RADIUS protocol message 106 is queued exceeds a duration threshold. In one embodiment, if the number of queued RADIUS protocol messages exceeds a threshold number, the RADIUS client 102 declares all new requests as failed until the number of queued RADIUS protocol messages decreases below the threshold.

In various embodiments, the RADIUS client 102 retransmits the RADIUS protocol message 106 to the RADIUS server 104 at a linear time interval (e.g., every few seconds) or an exponential time interval (e.g., increasing the number of seconds between transmissions along an exponential curve). In some embodiments, the RADIUS client 102 declares the request failed if a pre-specified maximum number of retransmission attempts are exceeded.

It is desirable to increase the number of possible active client requests pending at one time without adopting proprietary extensions to the RADIUS protocol because many legacy systems are configured for the RADIUS protocol.

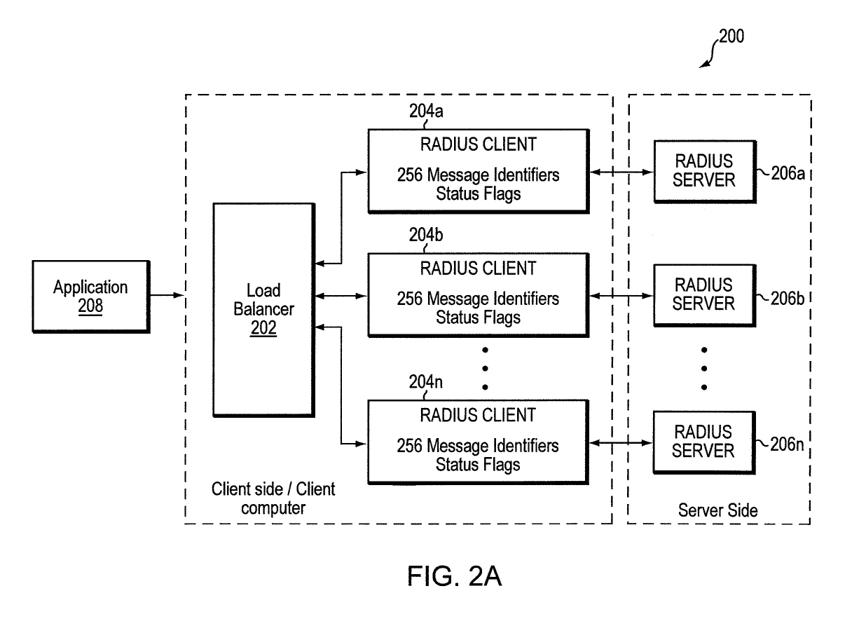

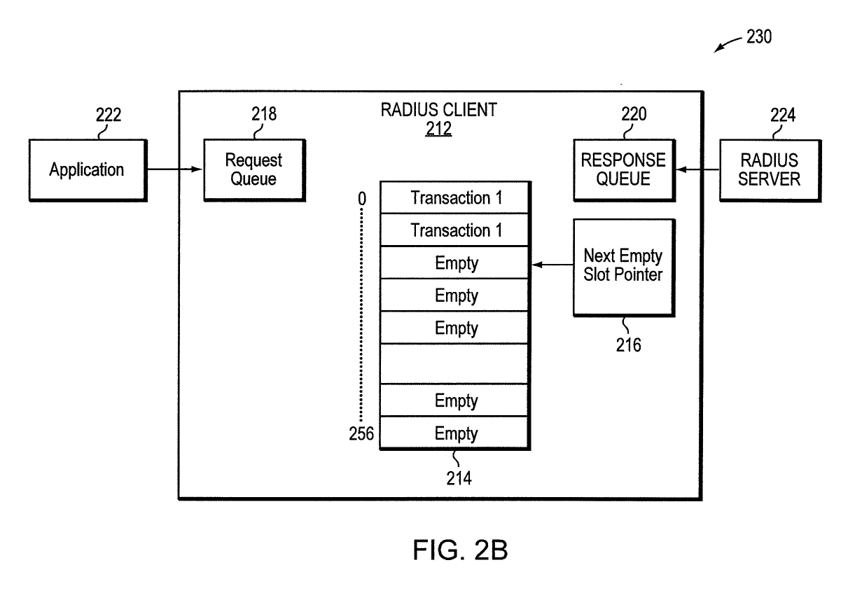

FIG. 2A is a diagram 200 showing RADIUS clients 204a, 204b, . . . ,204n, generally 204 and RADIUS servers 206a, 206b, . . . , 206n, generally, 206, according to an illustrative embodiment of the invention. A set of RADIUS protocol identifiers (e.g., all 256 unique combinations of the 8-bit ID field) is assigned to each RADIUS client 204. The number of possible active RADIUS client requests is 256 RADIUS protocol identifiers times the number of RADIUS clients 204 (e.g., 256 times 3 (768) if there are three RADIUS clients). In various embodiments, the number of RADIUS clients 204 is any number.

The load balancer 202 communicates with the RADIUS clients 204. The RADIUS clients 204 communicate with the RADIUS servers 206 via UDP ports (not shown). Specifically, RADIUS client 204a communicates with RADIUS server 206a, RADIUS client 204b communicates with RADIUS server 206b, and RADIUS client 204n communicates with RADIUS server 206n.

The load balancer 202 takes as input, requests for services from an application 208. The load balancer 202 transmits each request for services to one of the RADIUS clients 204 (e.g., RADIUS client 204a) based on whether or not the RADIUS protocol identifiers are assigned to an existing RADIUS transaction. Upon receipt of a request for services, each RADIUS client 204 creates an instance of a RADIUS protocol message and populates an identifier field of the RADIUS protocol message. The identifier field of the RADIUS protocol message is populated with an available identifier of the set of RADIUS protocol identifiers associated with the RADIUS client 204. The RADIUS client 204 transmits the request to one of the RADIUS servers 206, according to the communications described above.

In some embodiments, the RADIUS client 204 determines whether or not RADIUS protocol identifiers are assigned to an existing RADIUS transaction by checking status flags associated with the RADIUS protocol identifiers. In some embodiments, the load balancer 202 transmits each request for services to one of the RADIUS clients 204 based on utilization parameters. The utilization parameters include information that allows the system to determine when to use each of the RADIUS protocol identifiers. In various embodiments, the utilization parameters are flags that indicate, for example, availability of RADIUS clients, frequencies of RADIUS client usage, response times of RADIUS servers, and frequencies of RADIUS protocol identifiers usage, or any combination thereof.

In one embodiment, the utilization parameters are flags that indicate whether a particular RADIUS client 204 is available. In these embodiments, the load balancer 202 determines the utilization parameters based on the first available RADIUS client of the RADIUS clients 204.

In one embodiment, the utilization parameters are a number of times the RADIUS clients 204 are used and an order the RADIUS clients 204 are used. In these embodiments, the load balancer 202 determines the utilization parameters based on a round robin. For example, a first request for service is transmitted to the RADIUS client 204a, a second request for service is transmitted to the RADIUS client 204b, a third request for service is transmitted to the RADIUS client 204n, a fourth request is transmitted to the RADIUS client 204a, a fifth request is transmitted to the RADIUS client 204b, and so forth.

In one embodiment, the utilization parameters are response times of RADIUS servers. In these embodiments, the load balancer 202 determines the utilization parameters based on a response time of a RADIUS server with which the particular RADIUS client is in communication. For example, if at a first time RADIUS client 204a communicates with RADIUS server 206a that has a response time of 0.5 seconds and RADIUS client 204b communicates with RADIUS server 206b that has a response time of 0.2 seconds, the load balancer 204 selects the RADIUS client 204b to process the request because it has a quicker response time. Continuing with the same example, if at a second time RADIUS server 206a has a response time of 0.3 seconds and RADIUS server 206b has a response time of 0.6 seconds, the load balancer 204 selects the RADIUS client 204a to process the request because it has a quicker response time.

In one embodiment, the utilization parameters are frequencies of each RADIUS protocol identifiers usage. In these embodiments, the load balancer 202 determines the utilization parameters based on a number of RADIUS protocol identifiers used by each RADIUS client 204. For example, if RADIUS client 204a has 34 available RADIUS protocol identifiers and RADIUS client 204b has 200 available RADIUS protocol identifiers, then the load balancer 202 selects RADIUS client 204b to process the request.

In some embodiments, the load balancer 202 and the RADIUS clients 204 are implemented on a single client computer. In some embodiments, the load balancer 202 is implemented on a first client computer and the RADIUS clients are implemented on a second client computer. In one embodiment, the load balancer 202 and each of the RADIUS clients 204 are implemented on separate client computers.

In various embodiments, the RADIUS protocol message is transmitted via User Datagram Protocol (UDP) or Transmission Control Protocol (TCP) or Stream Control Transmission Protocol (SCTP), ReSerVation Protocol (RSVP).

FIG. 2B is a block diagram 230 showing details of an exemplary RADIUS client 212 allocating identifiers, according to an illustrative embodiment of the invention. The RADIUS client 212 includes a RADIUS protocol identifier array 214 and a next empty slot pointer 216. The RADIUS protocol identifier array 214 includes 256 array slots (e.g., 0 to 255), one for each possible RADIUS protocol identifier.

Each time an application 222 requests services from the RADIUS client 112, the request is input to a unprocessed request queue 218 with the requests received first in time first in line. Each request in the unprocessed request queue 218 is assigned a RADIUS protocol identifier and transmitted via a RADIUS protocol message to a RADIUS server 224 with the assigned RADIUS protocol identifier.

The requests are assigned a RADIUS protocol identifier that corresponds to a slot in the RADIUS protocol identifier array 214 to which the next empty slot pointer 216 points. The next empty slot pointer 216 initially points to slot 0. Each time a request is assigned a RADIUS protocol identifier, the next empty slot pointer 216 points to the next empty slot in the RADIUS protocol identifier array 214. Thus, each request is assigned a RADIUS protocol identifier that corresponds to a slot that is one number greater than the previous slot, until the next empty slot pointer reaches slot 255. Upon reaching slot 255, the next empty slot pointer 216 loops back to pointing to slot 0. For example, a first request is assigned an identifier corresponding to slot 0, a tenth request is assigned an identifier corresponding to slot 9, a two hundred and fifty sixth request is assigned an identifier corresponding to slot 255, and a two hundred and fifty seventh request is assigned an identifier corresponding to slot 0. Looping from slot 0 to 255 allows for each RADIUS protocol identifier to be used with substantially equal frequency and minimizes the frequency at which each RADIUS protocol identifier is received by the RADIUS serve 224, thus reducing the potential for a clash of RADIUS protocol identifiers at the RADIUS server 224.

Each time the RADIUS server 224 responds to the request for services from the RADIUS client 212, the response is input to an unprocessed response queue 220 with the responses received first in time first in line. Each response includes the same RADIUS protocol identifier used by the RADIUS client 212 to transmit the request to the RADIUS server 224. The RADIUS client 212 deletes each entry in the RADIUS protocol identifier array 214 that correspond to the RADIUS protocol identifiers of the responses in the unprocessed response queue 220 (i.e. completed transactions). The RADIUS protocol identifier that corresponds to the entry that is deleted in the RADIUS protocol identifier array 214 is “free” to be used by other requests for services.

In some embodiments, the RADIUS client 212 deletes each entry in the RADIUS protocol identifier array 214 that corresponds to a request for services that is not successfully transmitted to the RADIUS server 224. In some embodiments, the unprocessed request queue 218 assigns a time of receipt to each of the request for services. In some embodiments, the RADIUS client 212 retransmits all requests for services that are not successfully received by the RADIUS server 224 until a maximum duration for retransmission is met. In some embodiments, the maximum duration for retransmission is based on the time of receipt assigned by the unprocessed request queue 118.

Referring back to FIG. 2A, in some embodiments, the RADIUS clients 204 include an unprocessed request queue, a RADIUS protocol identifier array and a next empty slot pointer, as described above in FIG. 2B. In these embodiments, the load balancer 202 determines the utilization parameters based on availability of spaces in the unprocessed response queue and/or availability of slots in the RADIUS protocol identifier array.

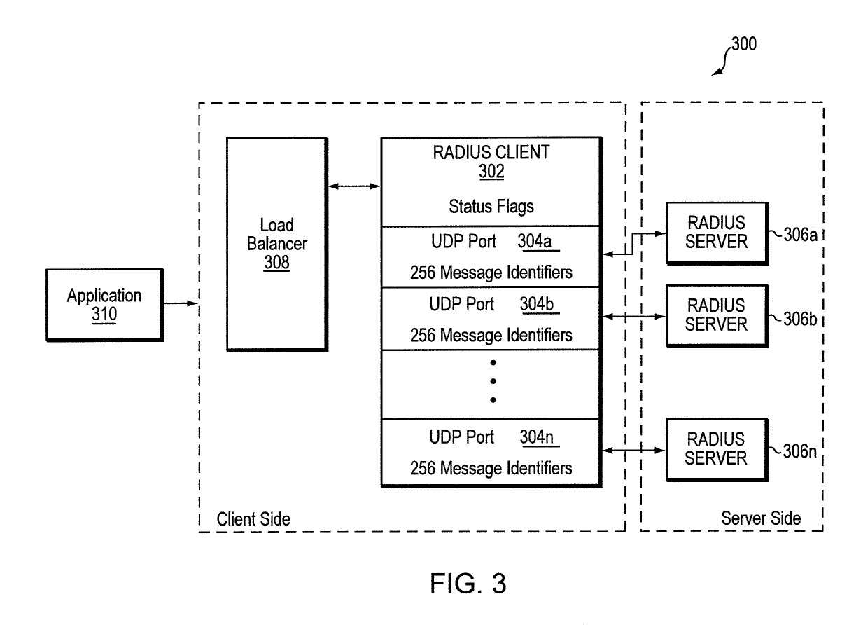

FIG. 3 is a block diagram 300 showing a RADIUS client 302 with UDP ports 304a, 304b, . . . , 304n, generally 304, and RADIUS servers 306a, 306b, . . . , 306n, generally 306, according to an illustrative embodiment of the invention. A set of RADIUS protocol identifiers (e.g., all unique combinations of the 8-bit ID field) is assigned to each UDP port 304. The number of possible active RADIUS client requests is 256 RADIUS protocol identifiers times the number of UDP ports 304 (e.g., 256 times 3 (768) if there are three UDP ports). In various embodiments, the number of UDP ports 304 is any number.

The load balancer 308 is in communication with the RADIUS client 302 that includes UDP ports 304. The RADIUS client 302 communicates with the RADIUS servers 306 via the UDP ports 304. Specifically, the RADIUS client 302 communicates with RADIUS server 306a via UDP port 304a, the RADIUS client 302 communicates with RADIUS server 306b via UDP port 304b, and the RADIUS client 302 communicates with the RADIUS server 306n via UDP port 304n.

A load balancer 308 takes as input, requests for services from an application 310. The load balancer 308 transmits requests for services to the RADIUS client 302 which selects transmission over one of the UDP ports (e.g., UDP port 304a) based whether or not the RADIUS protocol identifiers are assigned to an existing RADIUS transaction. The RADIUS client 302 creates an instance of a RADIUS protocol message associated with the one UDP port (e.g., UDP port 304a) and populates an identifier field of the RADIUS protocol message. The identifier field of the RADIUS protocol message is populated with an available identifier of the 256 identifiers associated with the one UDP port. The RADIUS client 302 transmits the request for services to one of the RADIUS servers 306 via the one UDP port, according to the communications described above.

In some embodiments, the RADIUS client 302 determines whether or not RADIUS protocol identifiers are assigned to an existing RADIUS transaction by checking status flags associated with the RADIUS protocol identifiers. In some embodiments, the load balancer 308 transmits each request for services to one of the UDP ports 304 based on utilization parameters (e.g., utilization parameters as described above in connection with FIG. 2A).

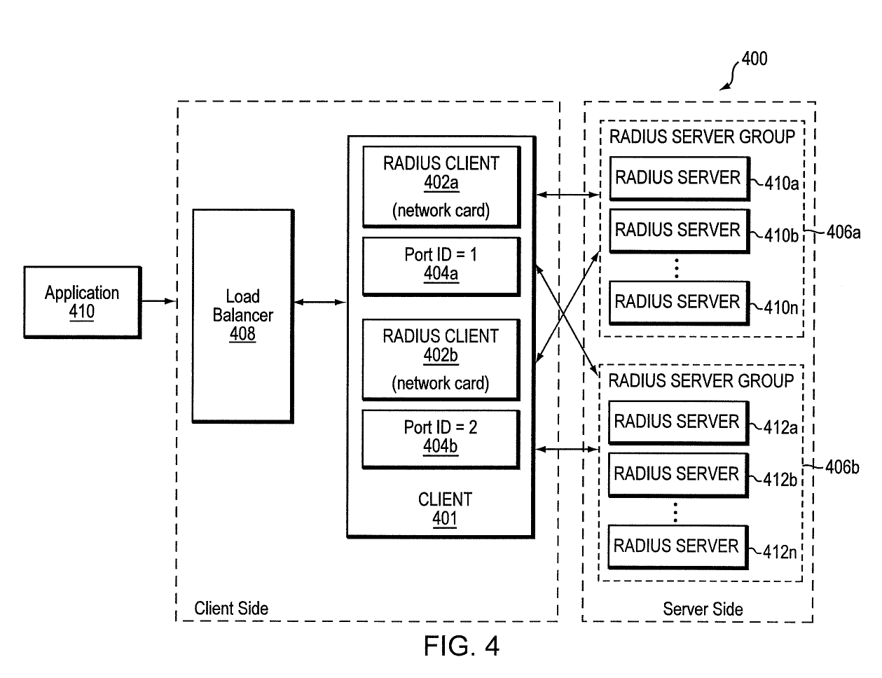

FIG. 4 is a block diagram 400 showing a client 401 and RADIUS server groups 406a and 406b, generally 406, according to an illustrative embodiment of the invention. The client 401 includes RADIUS client 402a and RADIUS client 402b, generally 402, and UDP ports 404a and UDP ports 404b, generally 404. RADIUS server group 406a includes RADIUS servers 410a, 410b, . . . , 410n, generally 410. RADIUS server group 406b includes RADIUS servers 412a, 412b, . . . , 412n, generally 412.

A set of RADIUS protocol identifiers (e.g., all unique combinations of the 8-bit ID field) is assigned to each unique pair of RADIUS clients 402 and UDP ports 404. For example, RADIUS client 402a and UDP port 404a are assigned a first set of RADIUS protocol identifiers, RADIUS client 402a and UDP port 404b are assigned a second set of RADIUS protocol identifiers, RADIUS client 402b and UDP port 404a are assigned a third set of RADIUS protocol identifiers, and RADIUS client 402b and UDP port 404b are assigned a fourth set of RADIUS protocol identifiers. The number of possible active RADIUS requests is 256 RADIUS protocol identifiers times the number of unique RADIUS client/UDP port pairs (e.g., 256 times 4 (1024) if there are four RADIUS client/UDP port pairs). In various embodiments, the number of RADIUS client/UDP port pairs any number.

The load balancer 408 is in communication with the client 401. RADIUS client 402a communicates with RADIUS server group 406a via UDP port 404a and RADIUS server group 406b via UDP port 404b, RADIUS client 402b communicates with RADIUS server group 406b via UDP port 404b and RADIUS server group 406a via UDP port 404a.

A load balancer 408 takes as input, requests for services from an application 410. The load balancer 408 transmits requests for services to the client 401 which selects transmission via one of the RADIUS clients 402a or 402b over one of the UDP ports 404a and 404b based on whether or not the RADIUS protocol identifiers are assigned to an existing RADIUS transaction. The one RADIUS client (e.g., RADIUS client 402a) creates an instance of a RADIUS protocol message associated with the one RADIUS client and the one UDP port (e.g., UDP port 404a) and populates an identifier field of the RADIUS protocol message. The identifier field of the RADIUS protocol message is populated with an available identifier of the set of RADIUS protocol identifiers associated with the one RADIUS client and the one UDP port.

In some embodiments, the RADIUS client 402 transmits to the RADIUS server group 406a or 406b based on criteria associated with the application that requested services. For example, the operator/domain for which the message is to be generated or the mappings/configurations of the application. In one embodiment, each RADIUS client 402 has an unique IP address.

In some embodiments, RADIUS servers 410 and 412 each have an unique IP address and IP port. In some embodiments, each RADIUS server 410 and 412 has a congestion handling routine that dictates the number of new requests for services each RADIUS server 410 and 412 handles. In some embodiments, the congestion handling routine determines when each RADIUS server 410 and 412 transmits a command to the client 401 to reduce the number of new requests for services transmitted to the particular RADIUS server. In some embodiments, the congestion handling routine is based on a number of unused RADIUS protocol identifiers. In some embodiments, reducing the number of new requests for services is based on a percentage of outstanding requests.

In some embodiments, each RADIUS server group 406 has a maximum of eight RADIUS servers. In some embodiments, each RADIUS server group 406 has any number of RADIUS servers.

In some embodiments, the RADIUS clients 402 retransmit requests to the same RADIUS server group even if the request is assigned to a different RADIUS server group by the load balancer 408 during the retransmission duration.

In some embodiments, the RADIUS clients 402 transmit the requests based on a transmission time associated with the request. In some embodiments, each RADIUS message associated with the request for services is transmitted from the RADIUS clients 402 to the RADIUS server group 406a or 406b at separate times. For example, the RADIUS messages for session start, session stop and session interim are transmitted at different times. In some embodiments, each RADIUS message associated with the request for services is transmitted from the RADIUS clients 402 to the RADIUS server 406a or 406b at the same time upon the RADIUS client 402 generating a RADIUS message “stop record” to stop the current RADIUS session.

In some embodiments, RADIUS client 402a and 402b and client 401 are implemented on one computer. In some embodiments, RADIUS client 402a and 402b are implemented on a first computer and client 401 is implemented on second computer. In some embodiments, RADIUS client 402a and 402b and client 401 are each implemented on different computer. In some embodiments, the load balancer 408 is implemented on a first computer and the RADIUS clients 402 and the client 401 are implemented on a second computer. In some embodiments, the load balancer 408 and the RADIUS clients 402 and client 401 are implemented on one computer.

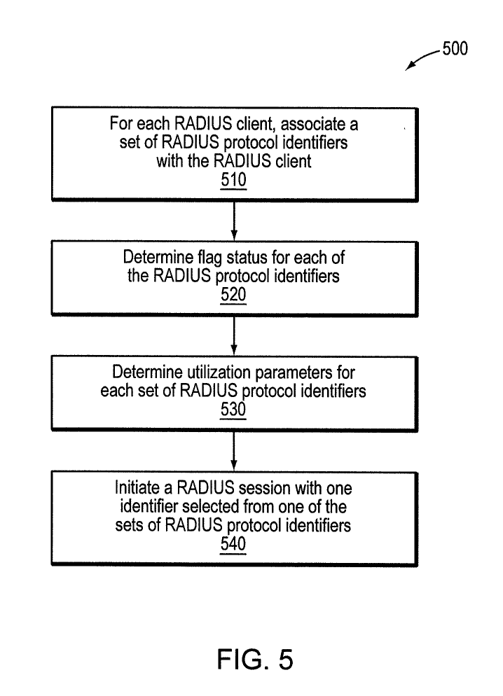

FIG. 5 is a flowchart 500 illustrating a method for an authentication and accounting system which communicates via a RADIUS protocol, according to an illustrative embodiment of the invention. The method includes associating a set of RADIUS protocol identifiers (e.g., the 256 identifiers as discussed above in FIG. 2A) with each RADIUS client (e.g., RADIUS clients 204 as discussed above in FIG. 2A) (Step 510).

The method also includes determining a status flag for each of the RADIUS protocol identifiers (Step 520). The status flag indicates whether a particular RADIUS protocol identifier is assigned to an existing RADIUS protocol transaction or not.

The method also includes determining utilization parameters for each set of RADIUS protocol identifiers (Step 530). As discussed above in connection with FIG. 2A, in various embodiments, the utilization parameters are RADIUS client availability flags, frequencies of RADIUS client usage, response times of RADIUS servers, and frequencies of each RADIUS protocol identifiers usage, or any combination thereof.

The method also includes initiating a RADIUS transaction with one identifier selected from one of the sets of RADIUS protocol identifiers (Step 540). The identifier is selected based on the status flag. In some embodiments, the identifier is selected based on the status flag and the utilization parameters.

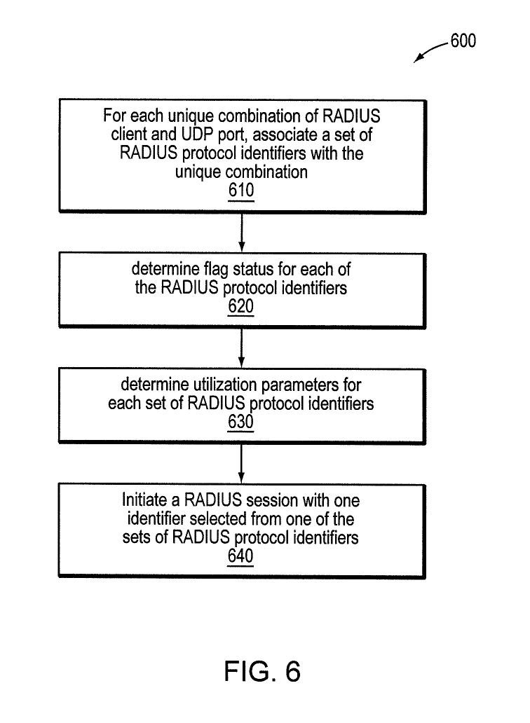

FIG. 6 is a flowchart 600 illustrating a method for an authentication and accounting system which communicates via a RADIUS protocol, according to an illustrative embodiment of the invention. The method includes associating a set of RADIUS protocol identifiers (e.g., the 256 identifiers as discussed above in FIG. 2A) with each RADIUS client (e.g., RADIUS clients 402 as discussed above in FIG. 4) and UDP ports (e.g., UDP ports 404 as discussed above in FIG. 4) (Step 610).

The method also includes determining a status flag for each of the RADIUS protocol identifiers (Step 620). The status flag indicates whether a particular RADIUS protocol identifier is assigned to an existing RADIUS protocol transaction or not.

The method also includes determining utilization parameters for each set of RADIUS protocol identifiers (Step 630). As discussed above in connection with FIG. 2A, in various embodiments, the utilization parameters are determined based on the first available RADIUS client, a round robin of RADIUS clients, a response time of RADIUS servers the RADIUS clients are in communication with, and/or a number of RADIUS protocol identifiers used in each RADIUS protocol identifier set.

The method also includes initiating a RADIUS transaction with one identifier selected from one of the sets of RADIUS protocol identifiers (Step 640). The identifier is selected based on the status flag. In some embodiments, the identifier is selected based on the status flag and the utilization parameters.

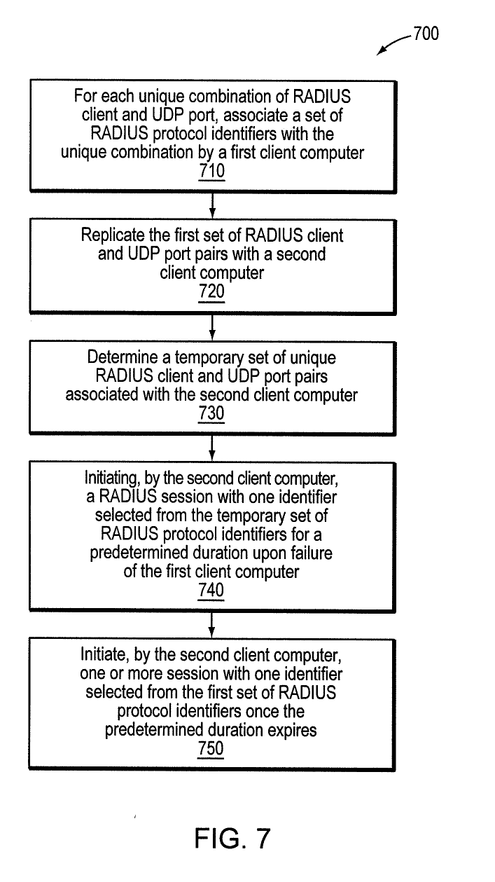

FIG. 7 is a flowchart 700 illustrating a method for an authentication and accounting system which communicates via a RADIUS protocol, according to an illustrative embodiment of the invention. The method includes associating a set of RADIUS protocol identifiers (e.g., the 256 identifiers as discussed above in FIG. 2A) with each RADIUS client (e.g., RADIUS clients 402 as discussed above in FIG. 4) and UDP ports (e.g., UDP ports 404 as discussed above in FIG. 4) (Step 710).

The method also includes replicating the first set of RADIUS client and UDP port pairs with a second client computer (Step 730). For example, replicating the unique RADIUS client and UDP port pairs of RADIUS client 404 and the RADIUS protocol identifiers on a RADIUS client other than RADIUS client 404, as described in Step 720.

The method also includes determining a temporary set of unique RADIUS client and UDP port pairs associated with the second client computer (Step 730).

The method also includes initiating, by the second client computer, a RADIUS transaction with one of the second sets of RADIUS protocol identifiers for a predetermined duration upon failure of the first client computer (Step 740). In one embodiment, the predetermined duration corresponds to the duration of time the RADIUS servers in communication with the failed first client computer takes to terminate the RADIUS transactions between the failed first client computer and the RADIUS servers.

The method also includes initiating by the second client computer one or more transaction with one identifier selected from one of the first sets of RADIUS protocol identifiers once the predetermined duration expires (Step 750).

In various embodiments, the disclosed methods may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The described embodiments of the invention are intended to be merely exemplary and numerous variations and modifications will be apparent to those skilled in the art. All such variations and modifications are intended to be within the scope of the present invention as defined in any appended claims.

1. A computer-implemented method for an authentication and accounting system which communicates via a RADIUS protocol, comprising:
determining, by a client computer, a status flag for each RADIUS protocol identifier in a first set of RADIUS protocol identifiers associated with a first RADIUS client and a second set of RADIUS protocol identifiers associated with a second RADIUS client, wherein the determination is based on whether each RADIUS protocol identifier is in use by an existing RADIUS transaction; and
initiating, by the client computer, a RADIUS transaction with one identifier, selected from the combination of the first set of RADIUS protocol identifiers and the second set of RADIUS protocol identifiers, based on the status flag of each of the RADIUS identifiers in the first set of RADIUS protocol identifiers and the second set of RADIUS protocol identifiers.

2. The computer-implemented method of claim 1, wherein each RADIUS protocol identifier in the first set of RADIUS protocol identifiers and the second set of RADIUS protocol identifiers is assigned when the status flag is present and unassigned when the status flag is not present.

3. The computer-implemented method of claim 1, wherein initiating a RADIUS transaction with the one identifier further comprises:
determining, by the client computer, utilization parameters for each of the first set of RADIUS protocol identifiers and the second set of RADIUS protocol identifiers; and
selecting the one identifier from the combination of the first set of RADIUS protocol identifiers and the second set of RADIUS protocol identifiers, based on the utilization parameters.

4. The computer-implemented method of claim 3, wherein determining utilization parameters further comprises:
determining a first number of RADIUS protocol identifiers in the first set of RADIUS protocol identifiers that are used by RADIUS transactions; and
determining a second number of RADIUS protocol identifiers in the second set of RADIUS protocol identifiers that are used by the RADIUS transactions.

5. The computer-implemented method of claim 3, wherein determining the utilization parameters comprises:
determining a first response time of a first RADIUS server associated with the first set of RADIUS protocol identifiers; and
determining a second response time of a second RADIUS server associated with the second set of RADIUS protocol identifiers.

6. The computer-implemented method of claim 1, further comprising tracking use of the first set of RADIUS protocol identifiers and the second set of RADIUS protocol identifiers by RADIUS transactions.

7. The computer-implemented method of claim 6, wherein tracking further comprises:
associating a first transaction array with the first set of RADIUS protocol identifiers and a second transaction array with the second set of RADIUS protocol identifiers, wherein each transaction array includes 256 slots that correspond to 256 identifiers available for RADIUS protocol identifiers; and
inserting an assigned status into a slot of the first transaction array or the second transaction array based on the RADIUS protocol identifier and the set of RADIUS protocol identifiers used to initiate each RADIUS transaction.

8. The computer-implemented method of claim 7, further comprising:
deleting the assigned status from the slot of the first transaction array or second transaction array based on receiving, by the client computer, an indication from a RADIUS server that the RADIUS transaction has ended.

9. The computer-implemented method of claim 1, wherein selecting the one identifier is further based on a first number of active transactions between the first RADIUS server associated with the first RADIUS client and a second number of active transactions between the first RADIUS server associated with a third client computer.

10. The computer-implemented method of claim 1, wherein selecting the one identifier is further based on whether the first RADIUS client associated with a RADIUS server or the second RADIUS client associated with the RADIUS server has more active transactions.

11. The computer-implemented method of claim 1, wherein selecting the one identifier is further based on whether the first RADIUS client or the second RADIUS client was last used to initiate a RADIUS transaction.

12. The computer-implemented method of claim 1, wherein the first RADIUS client is implemented on a second computer and the second RADIUS client is implemented on a third computer.

13. The computer-implemented method of claim 1, wherein the client computer includes further comprising a third set of RADIUS protocol identifiers associated with a third RADIUS client, and wherein the one identifier is selected from a combination of the first set of RADIUS protocol identifiers, the second set of RADIUS protocol identifiers and third set of RADIUS protocol identifiers.

14. A computer-implemented method for an authentication and accounting system which communicates via a RADIUS protocol, comprising:
determining, by a client computer, a status flag for each RADIUS protocol identifier in a first set of RADIUS protocol identifiers associated with a first UDP port and a second set of RADIUS protocol identifiers associated with a second UDP port, wherein the determination is based on whether each RADIUS protocol identifier is in use by an existing RADIUS transaction; and
initiating, by the client computer, a RADIUS transaction with one identifier selected from the combination of the first set of RADIUS protocol identifiers and the second set of RADIUS protocol identifiers based on the status of each of the RADIUS protocol identifiers in the first set of RADIUS protocol identifiers and the second set of RADIUS protocol identifiers.

15. The computer-implemented method of claim 14, wherein each RADIUS protocol identifier in the first set of RADIUS protocol identifiers and the second set of RADIUS protocol identifiers is assigned when the status flag is present and unassigned when the status flag is not present.

16. The computer-implemented method of claim 14, wherein initiating a RADIUS transaction with the one identifier further comprises:
determining, by the client computer, utilization parameters for each of the first set of RADIUS protocol identifiers and the second set of RADIUS protocol identifiers; and
selecting the one identifier from the combination of the first set of RADIUS protocol identifiers and the second set of RADIUS protocol identifiers, based on the utilization parameters.

17. The computer-implemented method of claim 16, wherein determining the utilization parameters further comprises:
determining a first number of RADIUS protocol identifiers in the first set of RADIUS protocol identifiers that are used by RADIUS transactions; and
determining a second number of RADIUS protocol identifiers in the second set of RADIUS protocol identifiers that are used by the RADIUS transactions.

18. The computer-implemented method of claim 16, wherein determining the utilization parameters comprises:
determining a first response time of a first RADIUS server associated with the first set of RADIUS protocol identifiers; and
determining a second response time of a second RADIUS server associated with the second set of RADIUS protocol identifiers.

19. The computer-implemented method of claim 14, further comprising tracking use of the first set of RADIUS protocol identifiers and the second set of RADIUS protocol identifiers by RADIUS transactions.

20. The computer-implemented method of claim 19, wherein tracking further comprises:
associating a first transaction array with the first set of RADIUS protocol identifiers and a second transaction array with the second set of RADIUS protocol identifiers, wherein each transaction array includes 256 slots that correspond to 256 identifiers available for RADIUS protocol identifiers; and
inserting an assigned status into a slot of the first transaction array or the second transaction array based on the RADIUS protocol identifier and the set of RADIUS protocol identifiers used to initiate each RADIUS transaction.

21. The computer-implemented method of claim 20, further comprising:
deleting the assigned status from the slot of the first transaction array or second transaction array based on receiving, by the client computer, an indication from a RADIUS server that the RADIUS transaction has ended.

22. The computer-implemented method of claim 14, wherein selecting the one identifier is further based on whether the first UDP port or the second UDP port was last used to initiate a RADIUS transaction.

23. A computer-implemented method for an authentication and accounting system which communicates via a RADIUS protocol, comprising:
determining, by a client computer, a status flag for each RADIUS protocol identifier in:
i) a first set of RADIUS protocol identifiers associated with a first UDP port and a first RADIUS client,
ii) a second set of RADIUS protocol identifiers associated with the first UDP port and a second RADIUS client,
iii) a third set of RADIUS protocol identifiers associated with a second UDP port and the first RADIUS client, and
iv) a fourth set of RADIUS protocol identifiers associated with the second UDP port and the second RADIUS client,
wherein the determination is based on whether each RADIUS protocol identifier is in use by an existing RADIUS transaction; and
initiating, by the client computer, a RADIUS transaction with one identifier selected from the combination of the first set of RADIUS protocol identifiers, the second set of RADIUS protocol identifiers, the third set of RADIUS protocol identifiers and the fourth set of RADIUS protocol identifiers based on the status and of each of the RADIUS protocol identifiers in the first set of RADIUS protocol identifiers, the second set of RADIUS protocol identifiers, the third set of RADIUS protocol identifiers and the fourth set of RADIUS protocol identifiers.

24. The computer-implemented method of claim 23, wherein initiating a RADIUS transaction with the one identifier further comprises:
determining, by the client computer, utilization parameters for each of the first set of RADIUS protocol identifiers, the second set of RADIUS protocol identifiers, the third set of RADIUS protocol identifiers and the fourth set of RADIUS protocol identifiers; and
selecting the one identifier from the combination of the first set of RADIUS protocol identifiers, the second set of RADIUS protocol identifiers, the third set of RADIUS protocol identifiers and the fourth set of RADIUS protocol identifiers, based on the utilization parameters.

25. A computer-implemented method for an authentication and accounting system which communicates via a RADIUS protocol, comprising:
determining, by a client computer, a status flag for each RADIUS protocol identifier in one or more sets of RADIUS protocol identifiers associated with a RADIUS client and an UDP port, wherein the determination is based on whether each RADIUS protocol identifier is in use by an existing RADIUS transaction; and
initiating, by the client computer, a RADIUS transaction with one identifier selected from the one or more RADIUS protocol identifiers based on the status and of each of the RADIUS protocol identifiers in the one or more sets of RADIUS protocol identifiers.

26. The computer-implemented method of claim 25, wherein initiating a RADIUS transaction with the one identifier further comprises:
determining, by the client computer, utilization parameters for each of the one or more sets of RADIUS protocol identifiers; and
selecting the one identifier from the combination of the one or more sets of RADIUS protocol identifiers, based on the utilization parameters.

27. A computer-implemented method for an authentication and accounting system which communicates via a RADIUS protocol, comprising:
determining, by a client computer, a status flag for each RADIUS protocol identifier in:
i) a first set of RADIUS protocol identifiers associated with a first RADIUS client and a UDP port,
ii) a second set of RADIUS protocol identifiers associated with a second RADIUS client and the UDP port,
wherein the determination is based on whether each RADIUS protocol identifier is in use by an existing RADIUS transaction; and
initiating, by the client computer, a RADIUS transaction with one identifier selected from the combination of the first set of RADIUS protocol identifiers and the second set of RADIUS protocol identifiers based on the status and of each of the RADIUS protocol identifiers in the first set of RADIUS protocol identifiers and the second set of RADIUS protocol identifiers.

28. The computer-implemented method of claim 27, wherein initiating a RADIUS transaction with the one identifier further comprises:
determining, by the client computer, utilization parameters for each of the first set of RADIUS protocol identifiers and the second set of RADIUS protocol identifiers; and
selecting the one identifier from the combination of the first set of RADIUS protocol identifiers and the second set of RADIUS protocol identifiers, based on the utilization parameters.

29. A computer-implemented method for an authentication and accounting system which communicates via a RADIUS protocol, comprising:
determining, by a client computer, unique UDP port and RADIUS client pairs, wherein each unique UDP port and RADIUS client pair includes:
i) a single UDP port from two or more UDP ports associated with the client computer, and
ii) a single RADIUS client from two or more RADIUS clients associated with the client computer;
determining, by the client computer, a status flag for each RADIUS protocol identifier in two or more sets of RADIUS protocol identifiers, wherein each set of the two or more sets of RADIUS protocol identifiers is associated with a unique UDP port and RADIUS client pair, and wherein the determination is based on whether each RADIUS protocol identifier is in use by an existing RADIUS transaction; and
initiating, by the client computer, a RADIUS transaction with one identifier selected from the combination of the two or more sets of RADIUS protocol identifiers based on the status of each of the RADIUS protocol identifiers in the two or more sets of RADIUS identifiers.

30. The computer-implemented method of claim 29, wherein initiating a RADIUS transaction with the one identifier further comprises:
determining, by the client computer, utilization parameters for each of the two or more sets of RADIUS protocol identifiers; and
selecting the one identifier from the combination of the two or more sets of RADIUS protocol identifiers, based on the utilization parameters.

31. A computer program product for an authentication and accounting system which communicates via a RADIUS protocol, tangibly embodied in a computer-readable storage medium, the computer program product containing instructions being operable to cause a data processing apparatus to:
determine, by a client computer, unique UDP port and RADIUS client pairs, wherein each unique UDP port and RADIUS client pair includes:
i) a single UDP port from two or more UDP ports associated with the client computer, and
ii) a single RADIUS client from two or more RADIUS clients associated with the client computer;
determine, by the client computer, a status flag for each RADIUS protocol identifier in two or more sets of RADIUS protocol identifiers, wherein each set of the two or more sets of RADIUS protocol identifiers is associated with a unique UDP port and RADIUS client pair, and wherein the determination is based on whether each RADIUS protocol identifier is in use by an existing RADIUS transaction; and
initiate, by the client computer, a RADIUS transaction with one identifier selected from the combination of the two or more sets of RADIUS protocol identifiers based on the status of each of the RADIUS protocol identifiers in the two or more sets of RADIUS identifiers and the load values.

32. The computer-implemented method of claim 31, wherein initiating a RADIUS transaction with the one identifier further comprises:
determining, by the client computer, utilization parameters for each of the two or more sets of RADIUS protocol identifiers; and
selecting the one identifier from the combination of the two or more sets of RADIUS protocol identifiers, based on the utilization parameters.

33. A system for an authentication and accounting system which communicates via a RADIUS protocol, comprising:
means for determining, by a client computer, unique UDP port and RADIUS client pairs, wherein each unique UDP port and RADIUS client pair includes:
i) a single UDP port from two or more UDP ports associated with the client computer, and
ii) a single RADIUS client from two or more RADIUS clients associated with the client computer;
means for determining, by the client computer, a status flag for each RADIUS protocol identifier in two or more sets of RADIUS protocol identifiers, wherein each set of the two or more sets of RADIUS protocol identifiers is associated with a unique UDP port and RADIUS client pairs, and wherein the determination is based on whether each RADIUS protocol identifier is in use by an existing RADIUS transaction; and
means for initiating, by the client computer, a RADIUS transaction with one identifier selected from the combination of the two or more sets of RADIUS protocol identifiers based on the status of each of the RADIUS protocol identifiers in the two or more sets of RADIUS identifiers.

34. The system of claim 33, wherein initiating a RADIUS transaction with the one identifier further comprises:
means for determining, by the client computer, utilization parameters for each of the two or more sets of RADIUS protocol identifiers; and
means for selecting the one identifier from the combination of the two or more sets of RADIUS protocol identifiers, based on the utilization parameters.

35. A computer-implemented method for an authentication and accounting system which communicates via a RADIUS protocol, comprising:
determining, by a first client computer, a first set of unique UDP port and RADIUS client pairs, wherein each unique UDP port and RADIUS client pair in the first set includes:
i) a single UDP port from two or more UDP ports associated with the first client computer, and
ii) a single RADIUS client from two or more RADIUS clients associated with the first client computer;
replicating, by a second client computer, the first set of unique UDP port and RADIUS client pairs determined by the first client computer;
determining, by the second client computer, a temporary set of unique UDP port and RADIUS client pairs, wherein each unique UDP port and RADIUS client pair in the temporary set includes:
i) a single UDP port from two or more UDP ports associated with the second client computer, and
ii) a single RADIUS client from two or more RADIUS clients associated with the second client computer;
initiating, by the second client computer, one or more RADIUS transactions with identifiers selected from the temporary set of unique UDP port and RADIUS client pairs in response to the detection of a failure event on the first client computer, wherein the one or more RADIUS transactions remain active for a predetermined duration; and
initiating, by the second client computer, one or more RADIUS transactions with identifiers selected from the first set of unique UDP port and RADIUS client pairs in response to expiration of the predetermined duration.
